(19) United States
(12) Patent Application Publication
(10) Pub. No.: US 2023/0366246 A1
(43) Pub. Date: Nov. 16, 2023

(54) VEHICLE DOOR LOCK DEVICE

(71) Applicant: AISIN CORPORATION, Kariya (JP)

(72) Inventor: Yuichiro TANAKA, Kariya-shi (JP)

(73) Assignee: AISIN CORPORATION, Kariya (JP)

(21) Appl. No.: 18/313,665

(22) Filed: May 8, 2023

(30) Foreign Application Priority Data
May 13, 2022 (JP) 2022-079284

(51) Int. Cl. E05B 85/24; E05B 77/06; E05B 83/36

(52) U.S. Cl. CPC E05B 85/24; E05B 77/06; E05B 83/36

(57) ABSTRACT

A vehicle door lock device includes: a latch mechanism; a first member rotatably supported with respect to a cabinet and configured to be movable between an initial position and an operating position; a second member rotatably supported by the first member, and configured to be movable among a first position, a second position, and a third position between the first position and the second position by rotating with respect to the first member, movable between the initial position and the operating position together with the first member; and a third member configured to allow movement of the second member by being elastically deformed while being in contact with the second member when the second member moves in a direction from the first position or the third position toward the second position, and configured to restrict the movement of the second member by engaging with the second member.

### CROSS REFERENCE TO RELATED APPLICATIONS

This application is based on and claims priority under 35 U.S.C. § 119 to Japanese Patent Application 2022-079284, filed on May 13, 2022, the entire content of which is incorporated herein by reference.

### TECHNICAL FIELD

This disclosure relates to a vehicle door lock device.

### BACKGROUND DISCUSSION

A vehicle door lock device described in JP 2019-183614A (Reference 1) includes a latch mechanism capable of switching between a latched state in which opening of a vehicle door is allowed and an unlatched state in which the opening of the vehicle door is not allowed, and an open link movable between an unlocked position and a locked position. The vehicle door lock device described in Reference 1 switches the latch mechanism from the latched state to the unlatched state when a door handle is operated in an unlocked state in which the open link is located at the unlocked position, and does not switch the latch mechanism to the latched state when the door handle is operated in a locked state in which the open link is located at the locked position.

The vehicle door lock device described in Reference 1 further includes a block member that moves to a block position when an inertial force is generated due to a collision or the like, and a biasing member that biases the block member in a predetermined direction. In the vehicle door lock device described in Reference 1, when the block member moves to the block position due to the inertial force, the block member enters a movement trajectory of the open link by the biasing member biasing the block member in the predetermined direction. Therefore, for the open link temporarily moved to the locked position due to the inertial force, after the input of the inertial force, the block member prevents the open link from moving toward the unlocked position. According to such a configuration, when an inertial force is generated due to a collision or the like, it is possible to prevent the vehicle door lock device from being switched to the unlocked state by preventing the open link from moving to the unlocked position.

However, in the configuration described in Reference 1, in order to prevent the vehicle door lock device from being switched from the locked state to the unlocked state when a side collision or the like occurs, two members, that is, the block member and the biasing member are required. Therefore, a component cost of the door lock device increases. In particular, since a dedicated member is required as the block member, the component cost is likely to increase. Further, since a space for arranging the block member and the biasing member is required in the door lock device, a size of the vehicle door lock device is increased.

A need thus exists for a vehicle door lock device which is not susceptible to the drawback mentioned above.

### SUMMARY

According to an aspect of this disclosure, a door lock device includes:
a latch mechanism configured to be switchable between a latched state in which opening of a vehicle door provided on a vehicle is not allowed and an unlatched state in which opening of the vehicle door is allowed;
a first member rotatably supported with respect to a cabinet and configured to be movable between an initial position and an operating position;
a second member rotatably supported by the first member, and configured to be movable among a first position, a second position, and a third position between the first position and the second position by rotating with respect to the first member, movable between the initial position and the operating position together with the first member, switch the latch mechanism from the latched state to the unlatched state when moving from the initial position to the operating position in a state of being located at the first position, and hold the latch mechanism in the latched state when moving from the initial position to the operating position in a state of being located at the third position; and
a third member configured to allow movement of the second member by being elastically deformed while being in contact with the second member when the second member moves in a direction from the first position or the third position toward the second position, be detached from the second member and return to a natural state when the second member moves to the second position, and restrict the movement of the second member by engaging with the second member when the second member moves in a direction from the second position toward the first position after the third member returns to the natural state.

### BRIEF DESCRIPTION OF THE DRAWINGS

The foregoing and additional features and characteristics of this disclosure will become more apparent from the following detailed description considered with the reference to the accompanying drawings, wherein:

FIG. 1A is a schematic diagram illustrating a configuration of a vehicle door;

FIG. 1B is a schematic diagram illustrating a configuration of the vehicle door;

FIG. 2 is a perspective view illustrating a configuration of a vehicle door lock device;

FIG. 3 is an exploded perspective view illustrating a configuration of the vehicle door lock device;

FIG. 4A is a diagram illustrating a configuration and an operation of the door lock device;

FIG. 4B is a diagram illustrating a configuration and an operation of the door lock device;

FIG. 5A is a diagram illustrating a configuration and an operation of the door lock device; and

FIG. 5B is a diagram illustrating a configuration and an operation of the door lock device;

FIG. 6A is a diagram illustrating a configuration of an inertial spring;

FIG. 6B is a diagram illustrating a configuration of the inertial spring;

FIG. 7A is a diagram illustrating a configuration and an operation of the door lock device;

FIG. 7B is a diagram illustrating a configuration and an operation of the door lock device.

### DETAILED DESCRIPTION

Hereinafter, an embodiment disclosed here will be described with reference to the drawings. In the following description, each direction of a vehicle door lock device 10 is based on each direction of a vehicle (vehicle body 301). In each drawing, a front side of the vehicle is indicated by an arrow Fr, a rear side of the vehicle is indicated by an arrow Rr, an upper side of the vehicle is indicated by an arrow Up, a lower side of the vehicle is indicated by an arrow Dw, an outer side of a vehicle width direction (left-right direction) of the vehicle is indicated by an arrow Out, and an inner side of the vehicle width direction of the vehicle is indicated by an arrow In.

### Vehicle Door

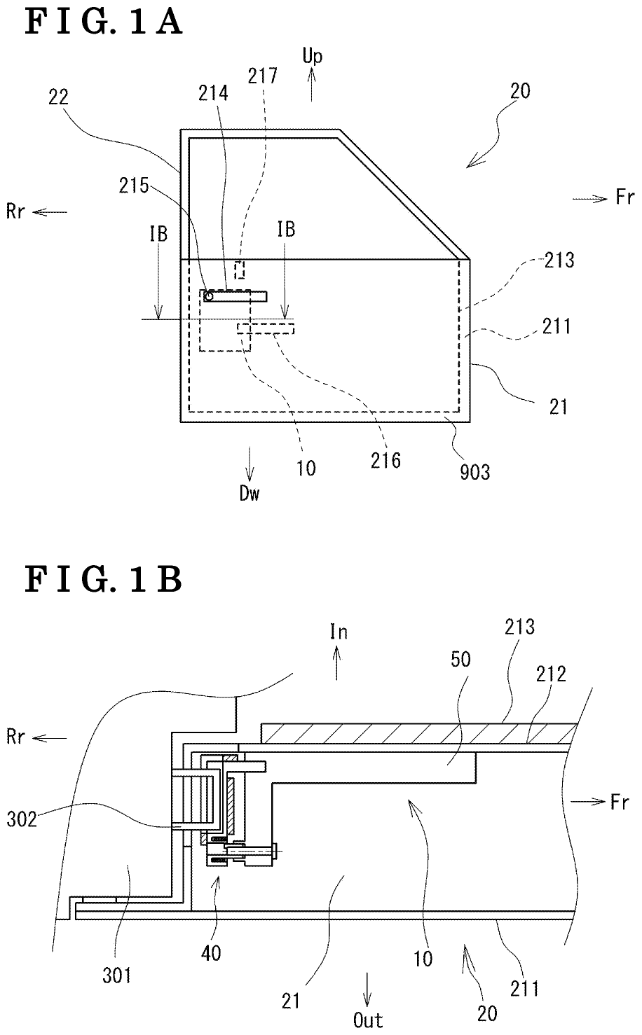

FIG. 1A is a side view of a vehicle door 20 to which the door lock device 10 is applied, and is a view seen from an exterior side. FIG. 1B is a cross-sectional view of the vicinity of a rear end portion of the vehicle door 20 to which the door lock device 10 is applied, and is a cross-sectional view taken along line IB-IB in FIG. 1A.

The vehicle door 20 is attached to the vehicle body 301 in an openable and closable manner. Specifically, a tip end portion of the vehicle door 20 is rotatably coupled to the vehicle body 301, and the vehicle door 20 is movable between a closed position and an open position by rotating with respect to the vehicle body 301. The closed position is a position at which the vehicle door 20 closes an opening portion provided in the vehicle body 301 for getting in and off the vehicle body 301, and the open position is a position at which the opening portion is not closed. The vehicle door 20 includes a door body portion 21 constituting a lower half portion of the vehicle door 20, and a door sash 22 provided on an upper half portion of the vehicle door 20. The door body portion 21 includes an outer panel 211, an inner panel 212, and a trim 213. The outer panel 211 constitutes an outer surface of the vehicle door 20. The inner panel 212 is located on an interior side of the outer panel 211, and is fixed to the outer panel 211. The trim 213 is fixed to an interior side of the inner panel 212, and constitutes an inner surface of the door body portion 21.

An outside door handle 214 and a key cylinder 215 are attached in the vicinity of a rear end portion of the outer panel 211. The outside door handle 214 is an operation member that can be manually operated by a user of the vehicle, and is movable between an initial position and an operating position by rotating with respect to the vehicle door 20. The outside door handle 214 is elastically biased toward the initial position by a biasing member (not illustrated), and is held at the initial position by a biasing force of the biasing member in a state in which the outside door handle 214 is not operated by the user (a state in which an external force is not applied). The key cylinder 215 includes an inner cylinder (also referred to as a plug). A suitable key is able to be inserted into and removed from the inner cylinder in a state in which the inner cylinder is located at a neutral position. The inner cylinder is rotatable between a locked position and an unlocked position. The locked position is a position to which the inner cylinder is rotated from the neutral position in a predetermined direction in a state in which the suitable key is inserted. The unlocked position is a position to which the inner cylinder is rotated in a direction opposite to the predetermined direction. The inner cylinder is constantly elastically biased toward the neutral position by the biasing member, and is held at the neutral position in a state in which the inner cylinder is not operated by the key (a state in which no external force is applied).

An inside door handle 216 and a lock knob 217 are attached to the inner panel 212. The inside door handle 216 is an operation member that can be manually operated by the user of the vehicle, and is rotatable and movable between an initial position and an operating position by rotating with respect to the vehicle door 20. The inside door handle 216 is elastically biased toward the initial position by a biasing member (not illustrated), and is held at the initial position in a state in which the inside door handle 216 is not operated by the user (a state in which an external force is not applied). The lock knob 217 is an operation member that can be manually operated by the user. The lock knob 217 is located in the vicinity of an upper end of the trim 213, and is movable between a locked position and an unlocked position by moving in an upper-lower direction with respect to, for example, the vehicle door 20. The position to which the lock knob 217 is attached is not limited. For example, the lock knob 217 may be attached in the vicinity of the inside door handle 216.

### Door Lock Device

As illustrated in FIG. 1B, the door lock device 10 is disposed in an internal space of the vehicle door 20 (that is, a space surrounded by the inner panel 212 and the outer panel 211). The door lock device 10 is fixed to the inner panel 212 (that is, the vehicle door 20). A part of the door lock device 10 is exposed to the outside of the vehicle door 20 at the rear end portion of the vehicle door 20.

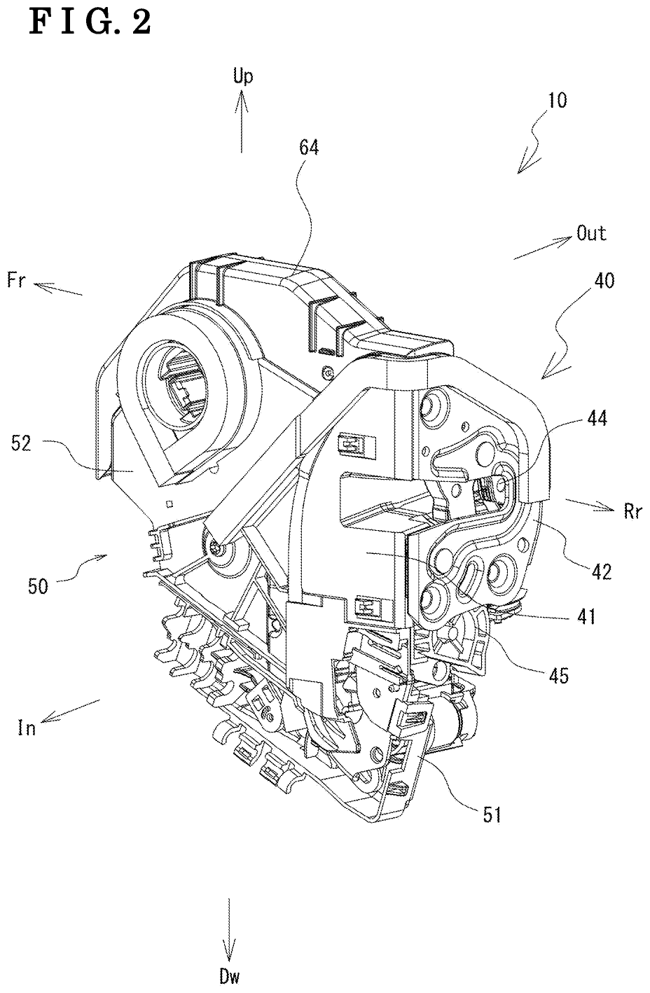

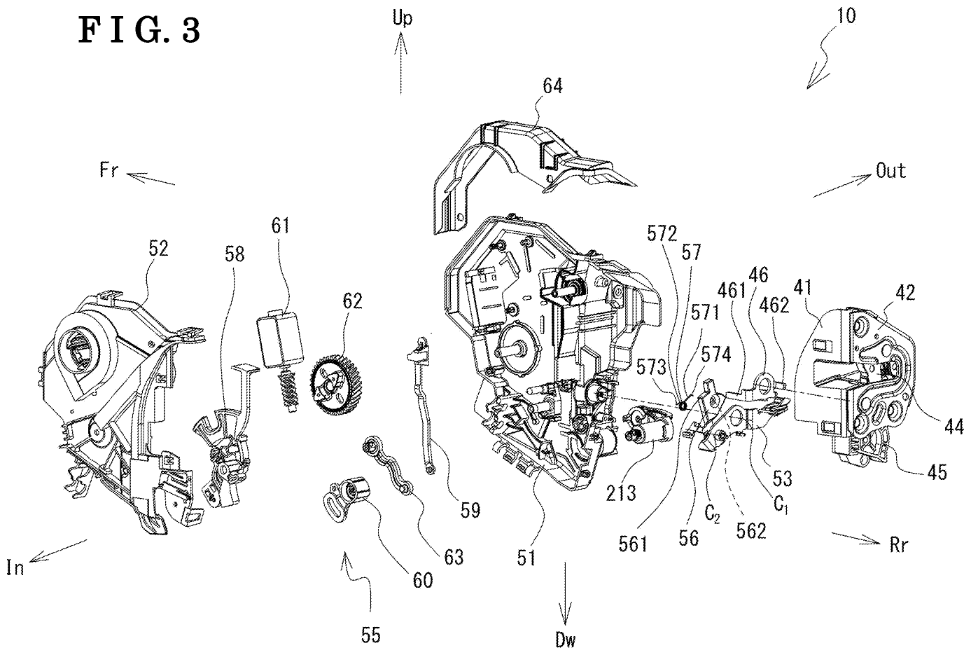

FIG. 2 is an external perspective view of the door lock device 10. FIG. 3 is an exploded perspective view of the door lock device 10. As illustrated in FIGS. 2 and 3, the door lock device 10 includes a meshing body 40 and an actuator body 50.

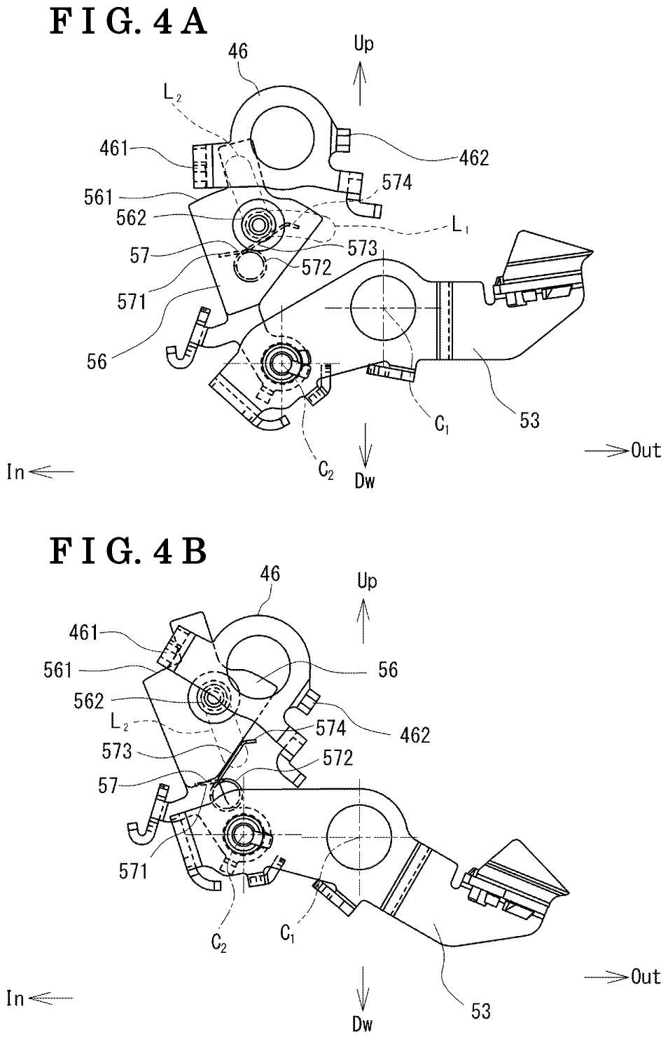

The meshing body 40 includes a base member 41, a base plate 42, a sub-plate (not illustrated), a latch 44, a pawl 45, a lift lever 46, a latch return spring (not illustrated), and a pawl return spring (not illustrated). The base member 41, the base plate 42, and the sub-plate constitute a cabinet of the meshing body 40. The latch 44, the pawl 45, the lift lever 46, the latch return spring, and the pawl return spring constitute a latch mechanism. The latch mechanism is switchable between an unlatched state and a latched state. The unlatched state is a state in which the vehicle door 20 is allowed to move from the closed position to the open position. The latched state is a state in which the vehicle door 20 is not allowed to move from the closed position to the open position (is restricted from moving). In the present embodiment, the latch mechanism is held in the latched state when the lift lever 46 is located at a latch engagement position (see FIG. 4A) described later. When the latch mechanism is in the latched state, the latch mechanism is switched from the latched state to the unlatched state when the lift lever 46 moves from the latch engagement position to a latch non-engagement position (see FIG. 4B) described later. A configuration of the lift lever 46 will be described later.

The actuator body 50 includes a housing 51, a cover 52, an open lever 53, and a lock mechanism 55. The housing 51 and the cover 52 constitute a cabinet of the actuator body 50. A waterproof cover 64 for preventing water or the like from entering an interior of the actuator body 50 is attached to the cabinet. The lock mechanism 55 includes an open link 56 and an inertial spring 57. The lock mechanism 55 is switchable between an unlocked state and a locked state. When the outside door handle 214 or the inside door handle 216 is operated (moved from the initial position to the operating position) while the latch mechanism is in the latched state, the unlocked state of the lock mechanism 55 is a state in which the latch mechanism is switched from the latched state to the unlatched state. When the outside door handle 214 or the inside door handle 216 is operated while the latch mechanism is in the latched state, the locked state of the lock mechanism 55 is a state in which the latch mechanism is held in the latched state (the latch mechanism is not switched from the latched state to the unlatched state). A configuration example of the lock mechanism 55 will be described later.

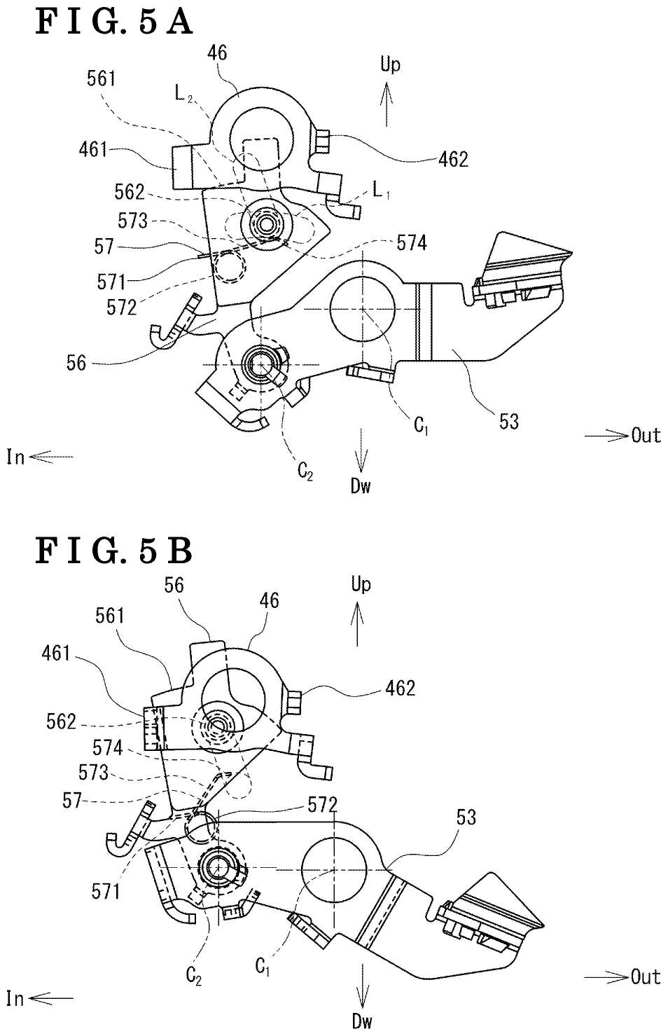

Here, configurations and operations of the lift lever 46 of the latch mechanism, the open lever 53, and the open link 56 of the lock mechanism 55 will be described. FIGS. 4A, 4B, 5A, and 5B are diagrams illustrating the configurations and the operations of the lift lever 46, the open lever 53, and the open link 56, and are diagrams viewed from a rear side. FIG. 4A illustrates a state in which the lock mechanism 55 is in the unlocked state and the open lever 53 is located at an initial position. FIG. 4B illustrates a state in which the lock mechanism 55 is in the unlocked state and the open lever 53 is located at an operating position. FIG. 5A illustrates a state in which the lock mechanism 55 is in the locked state and the open lever 53 is located at the initial position. FIG. 5B illustrates a state in which the lock mechanism 55 is in the locked state and the open lever 53 is located at the operating position.

The lift lever 46 of the latch mechanism includes a pressed portion 461 and a pawl engagement portion 462. The pressed portion 461 is a portion detachably engaged with a lift lever engagement portion 561 of the open link 56 described later, and has, for example, a protruding configuration protruding forward. The pawl engagement portion 462 is a portion that engages with the pawl 45 of the latch mechanism, and has, for example, a protruding configuration protruding rearward. The lift lever 46 is rotatably supported with respect to the cabinet of the meshing body 40 and is rotatable about an axis line substantially parallel to a front-rear direction. The lift lever 46 is disposed on a front side of the pawl 45, and rotates integrally with the pawl 45 when the pawl engagement portion 462 protruding rearward engages with the pawl 45. The lift lever 46 (and the pawl 45) is movable between the latch engagement position illustrated in FIGS. 4A, 5A, and 5B and the latch non-engagement position illustrated in FIG. 4B, by rotating with respect to the cabinet of the meshing body 40. As illustrated in the drawings, the latch non-engagement position of the lift lever 46 is a position at which the pressed portion 461 is moved higher than when the lift lever 46 is located at the latch engagement position. As described above, when the lift lever 46 (and the pawl 45) is located at the latch engagement position, the pawl 45 restricts the rotation of the latch 44 in the latched state, so that the latch mechanism is held in the latched state. When the lift lever 46 is moved from the latch engagement position to the latch non-engagement position, the pawl 45 allows the rotation of the latch 44, so that the latch mechanism is switched from the latched state to the unlatched state.

The open lever 53 is an example of a first member disclosed here. The open lever 53 is a long plate-shaped member, and is disposed in a direction in which a longitudinal direction is substantially parallel to the vehicle width direction. The open lever 53 is rotatably supported with respect to the housing 51, which is the cabinet of the actuator body 50, and is rotatable about an axis line (rotation center line C₁) substantially parallel to the front-rear direction. The open lever 53 is movable between the initial position illustrated in FIGS. 4A and 5A and the operating position illustrated in FIGS. 4B and 5B, by rotating with respect to the cabinet. As illustrated in the drawings, the operating position of the open lever 53 is a position at which an end portion of the open lever 53 inner in the vehicle width direction (an end portion on a side to which the open link 56 to be described later is attached) is located higher than when the open lever 53 is located at the initial position.

The open lever 53 is coupled to the outside door handle 214 via a predetermined coupling member (for example, a rod or a wire). When the outside door handle 214 is operated (moved from the initial position to the operating position), the open lever 53 moves from the initial position to the operating position in conjunction with the movement of the outside door handle 214. When the inside door handle 216 is operated (moved from the initial position to the operating position), the open lever 53 also moves from the initial position to the operating position in conjunction with the movement of the inside door handle 216. The open lever 53 is constantly elastically biased toward the initial position by an open lever return spring (not illustrated). Therefore, the open lever 53 is held at the initial position in a state in which no external force other than the biasing force of the open lever return spring is applied (that is, a state in which neither the outside door handle 214 nor the inside door handle 216 is operated).

The open link 56 is an example of a second member disclosed here. The open link 56 includes the lift lever engagement portion 561 and an inertial spring engagement portion 562. The lift lever engagement portion 561 is a portion detachably engaged with (in contact with and detachable from) a lower end of the pressed portion 461 of the lift lever 46 from below. Specifically, the lift lever engagement portion 561 is a portion provided with a surface facing substantially upward. The inertial spring engagement portion 562 is a portion detachably engaged with a movable arm 573 of the inertial spring 57 described later. Specifically, the inertial spring engagement portion 562 is a protruding portion protruding forward.

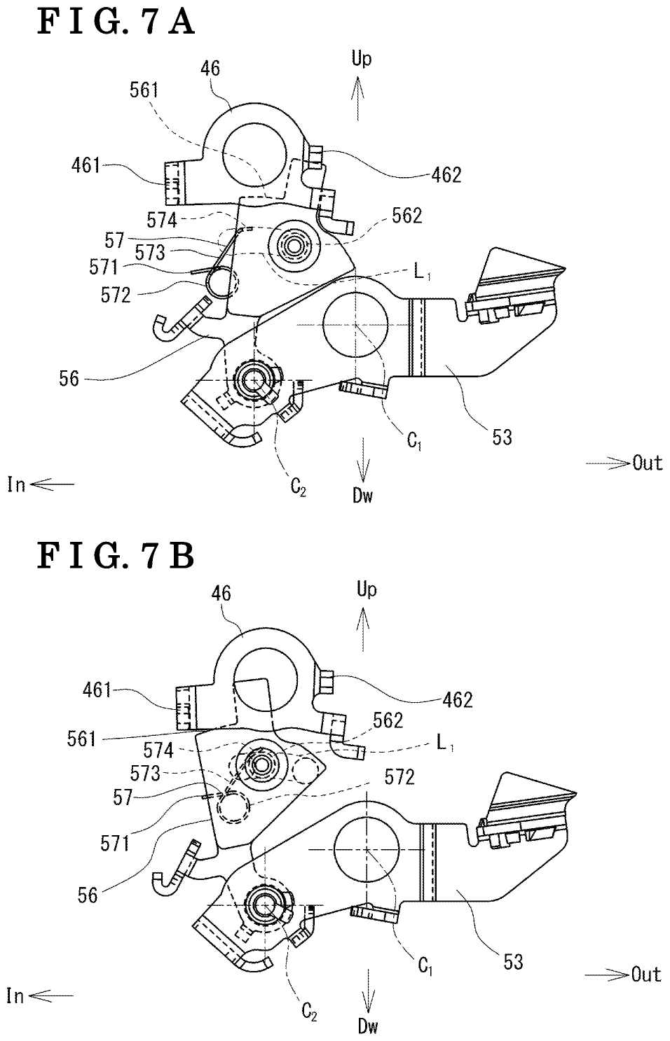

The open link 56 is rotatably supported with respect to the open lever 53 below the lift lever engagement portion 561 and the inertial spring engagement portion 562 and in the vicinity of the end portion of the open lever 53 inner in the vehicle width direction, and is rotatable about an axis line (rotation center line C₂) substantially parallel to the front-rear direction. Therefore, when the open link 56 rotates with respect to the open lever 53, the lift lever engagement portion 561 and the inertial spring engagement portion 562 reciprocate substantially in the vehicle width direction while drawing an arc trajectory (swing like a pendulum). The open link 56 is movable among an unlocked position shown in FIGS. 4A and 4B, a locked position shown in FIGS. 5A and 5B, and an inertia input position (to be described later with reference to FIG. 7A) by rotating with respect to the open lever 53 and moving substantially in the vehicle width direction.

The unlocked position of the open link 56 is an example of a first position of the second member disclosed here. The unlocked position of the open link 56 is a position on an end portion of the open link 56 or in the vicinity of the end portion inner in the vehicle width direction in a range in which the open link 56 is movable. The inertia input position of the open link 56 is an example of a second position of the second member disclosed here. The inertia input position of the open link 56 is a position on the end portion of the open link 56 or in the vicinity of the end portion outer in the vehicle width direction in a range in which the open link 56 is movable. The locked position of the open link 56 is an example of a third position of the second member disclosed here. The locked position of the open link 56 is an intermediate position between the unlocked position and the inertia input position.

A state in which the open link 56 is located at the unlocked position is the unlocked state of the lock mechanism 55, and a state in which the open link 56 is located at the locked position is the locked state of the lock mechanism 55. The open link 56 is movable between the unlocked position and the locked position (that is, the lock mechanism 55 is switchable between the unlocked state and the locked state) by a predetermined operation of the user of the vehicle and a driving force of an actuator 61 described later (described later). In the following description, when the open link 56 moves to the unlocked position, the locked position, and the inertia input position in a state in which the open lever 53 is located at the initial position, a movement trajectory of the inertial spring engagement portion 562 is referred to as a “first movement trajectory”. In each drawing, a substantially arc-shaped range surrounded by a broken line L₁ is the first movement trajectory.

The open link 56 is movable together with the open lever 53 between an initial position illustrated in FIGS. 4A and 5A and an operating position illustrated in FIGS. 4B and 5B in a state in which the open link 56 is located at the unlocked position and the locked position. The operating position of the open link 56 is a position at which the lift lever engagement portion 561 and the inertial spring engagement portion 562 are located higher than when the open link 56 is located at the initial position. A movement trajectory of the inertial spring engagement portion 562 when the open link 56 moves between the initial position and the operating position is referred to as a “second movement trajectory”. In each drawing, a linear range surrounded by a broken line L₂ is the second movement trajectory.

As illustrated in FIG. 4A, in a state in which the open lever 53 is located at the initial position, when the open link 56 is located at the unlocked position (that is, when the lock mechanism 55 is in the unlocked state), the lift lever engagement portion 561 of the open link 56 is located immediately below the pressed portion 461 of the lift lever 46. In this state, when one of the outside door handle 214 and the inside door handle 216 is operated, the open lever 53 and the open link 56 move to the operating positions as illustrated in FIG. 4B.

When the open link 56 moves together with the open lever 53 from the initial position to the operating position, the lift lever engagement portion 561 of the open link 56 is in contact with the pressed portion 461 of the lift lever 46 to push up the pressed portion 461. Therefore, the lift lever 46 (and the pawl 45) moves from the latch engagement position to the latch non-engagement position. As a result, the latch mechanism is switched from the latched state to the unlatched state. Thus, when the lock mechanism 55 is in the unlocked state, the latch mechanism is allowed to be switched from the latched state to the unlatched state. The unlocked position of the open link 56 can also be referred to as a “position at which the lift lever 46 can be moved from the latch engagement position to the latch non-engagement position by pushing the lift lever 46 when the open link 56 moves together with the open lever 53 from the initial position to the operating position”.

As illustrated in FIG. 5A, the locked position of the open link 56 is a position at which the lift lever engagement portion 561 of the open link 56 is shifted with respect to the pressed portion 461 of the lift lever 46 outer in the vehicle width direction. In a state in which the open link 56 is located at the locked position (that is, the lock mechanism 55 is in the locked state), when the outside door handle 214 or the inside door handle 216 is operated, the open lever 53 and the open link 56 move from the initial positions to the operating positions as illustrated in FIG. 5B. However, since the lift lever engagement portion 561 of the open link 56 does not contact the pressed portion 461 of the lift lever 46, the lift lever 46 does not move from the latch engagement position. Therefore, the latch mechanism is not switched from the latched state to the unlatched state, and is held in the latched state. Thus, when the lock mechanism 55 is in the locked state, the latch mechanism is held in the latched state even when the user or the like operates the outside door handle 214 and the inside door handle 216.

As described above, the lock mechanism 55 is switchable between the unlocked state and the locked state. The lock mechanism 55 is switched from the unlocked state to the locked state when the open link 56 moves from the unlocked position to the locked position, and is switched from the locked state to the unlocked state when the open link 56 moves from the locked position to the unlocked position.

### Inertial Spring

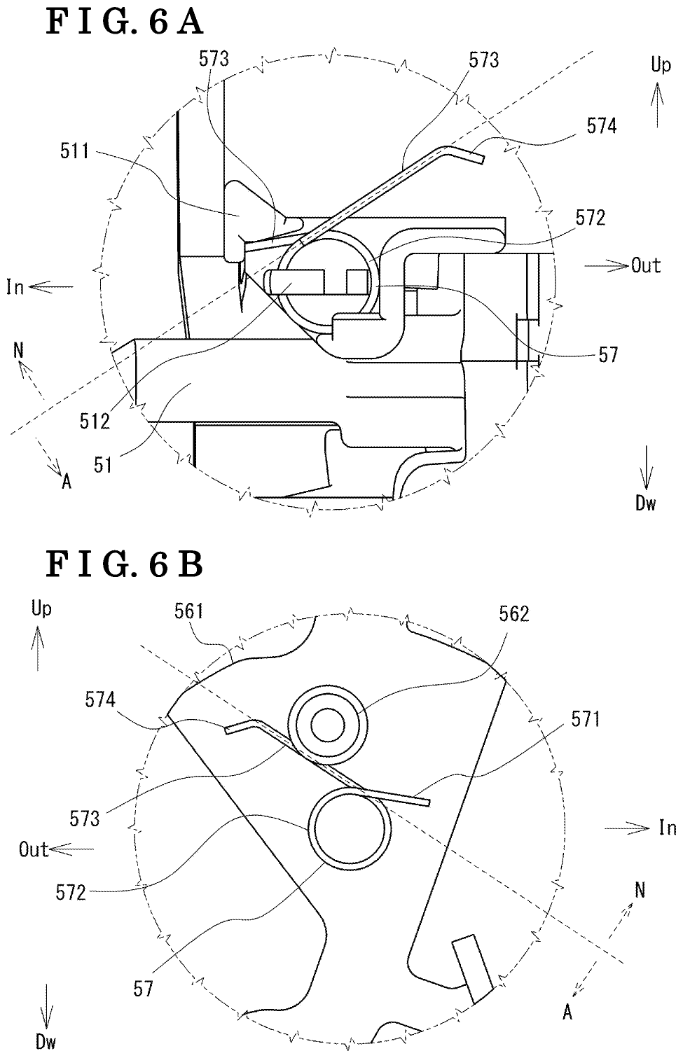

Next, the inertial spring 57 will be described. The inertial spring 57 is an example of a third member disclosed here. FIGS. 6A and 6B are diagrams illustrating a configuration of the inertial spring 57. FIG. 6A is a view from the rear side, and FIG. 6B is a view from the front side. The inertial spring 57 is a member that allows, when the open lever 53 is located at the initial position, the movement of the open link 56 from the unlocked position and the locked position to the inertia input position, but restricts (prevents) the movement of the open link 56 from the inertia input position to the unlocked position. The inertial spring 57 is disposed forward of the open link 56 and is adjacent to and aligned with the open link 56 in the front-rear direction. When viewed in the front-rear direction, at least a part of the inertial spring 57 overlaps the open link 56.

The inertial spring 57 is an elastically deformable torsion spring (also referred to as a torsion spring) including a coiled portion 572 and two arms extending from both ends of the coiled portion 572. The coiled portion 572 and one of the two arms are located outside the first movement trajectory of the open link 56 and below the first movement trajectory, and are fixed to the housing 51 which is a cabinet. One of the arms is referred to as a fixed arm 571. For example, protruding engagement portions 511 and 512 protruding rearward are provided in the cabinet (housing 51), and the fixed arm 571 and the coiled portion 572 are engaged with the engagement portions 511 and 512 and are fixed to the cabinet. Thus, in the present embodiment, the fixed arm 571 and the coiled portion 572 are examples of attachment units disclosed here. The fixed arm 571 and the coiled portion 572 may be not both attached to the cabinet, and at least one of the fixed arm 571 and the coiled portion 572 may be attached to the cabinet.

The other one of the two arms protrudes in a predetermined direction in a plane perpendicular to a rotation center line (that is, the substantially front-rear direction) of the open link 56. The other one of the arms is referred to as the movable arm 573. The movable arm 573 is a linear rod-shaped portion in a state of not being elastically deformed (hereinafter, a state of not being elastically deformed may be referred to as a “natural state”). A hook portion 574 is provided at a tip end portion of the movable arm 573. The hook portion is an example of an extending portion disclosed here. The hook portion 574 is a portion extending toward the inertia input position when the inertial spring 57 is in the natural state. Specifically, the hook portion 574 is a rod-shaped portion inclined at a predetermined angle with respect to a portion closer to a base end of the hook portion 574. The movable arm 573 extends in a direction in which a tip end of the movable arm 573 is located outer in the vehicle width direction and higher than a base end of the movable arm 573. In the natural state in which the inertial spring 57 is not elastically deformed, at least a part of the movable arm 573 enters the first movement trajectory L₁ and the second movement trajectory L₂ (see FIGS. 4B and 7A). A position at which at least a part of the movable arm 573 enters the first movement trajectory L₁ is an example of an internal position of the movable arm 573 disclosed here. Therefore, it can be said that “the movable arm 573 is constantly elastically biased toward a position (internal position) at which at least a part of the movable arm 573 enters the first movement trajectory L₁”. The internal position is not a specific point but a certain range. In a state in which the inertial spring 57 is not elastically deformed, the tip end portion of the movable arm 573 is located outer in the vehicle width direction and higher than the base end portion of the movable arm 573 (a side close to the coiled portion 572).

The movable arm 573 is inclined with respect to an extending direction of the first movement trajectory L₁ substantially parallel to the vehicle width direction and an extending direction of the second movement trajectory L₂ substantially parallel to the upper-lower direction. Specifically, the movable arm 573 is inclined with respect to the extending direction of the first movement trajectory L₁ in a direction in which the tip end portion of the movable arm 573 is located higher than the base end portion of the movable arm 573 and is located “closer to the first movement trajectory L₁ than the base end portion outer in the vehicle width direction (is located on closer to the position of the inertial spring engagement portion 562 of the open link 56 when the open lever 53 is located at the inertia input position)” (strictly, since the first movement trajectory L₁ has an arc shape, it can be said that “the movable arm 573 is inclined with respect to a tangent line of the extending direction of the first movement trajectory L₁”). The movable arm 573 is inclined with respect to the extending direction of the second movement trajectory L₂ in a direction in which the tip end portion is located “more upward of the second movement trajectory L₂ than the base end portion (is located closer to the position of the inertial spring engagement portion 562 of the open link 56 when the open lever 53 is located at the operating position) and is located outer in the vehicle width direction.

As illustrated in FIGS. 4A, 4B, 5A, and 5B, in a normal state, that is, when the open link 56 is located between the unlocked position and the locked position, the inertial spring engagement portion 562 of the open link 56 is located inner in the vehicle width direction (also referred to obliquely upward) with respect to the movable arm 573 and an extension line of the movable arm 573. In the following description, the inner side of the vehicle width direction (oblique upside) of the movable arm 573 and the extension line thereof may be referred to as a “normal side”. On the other hand, an oblique downside (the outer side of the vehicle width direction) of the movable arm 573 and the extension line thereof may be referred to as a “restriction side”. In FIGS. 6A and 6B, the normal side is indicated by an arrow N, and the restriction side is indicated by an arrow A.

The movable arm 573 is able to reciprocate like a pendulum (swing) in a plane perpendicular to the rotation center line C₂ of the open link 56 about the vicinity of the base end portion mainly due to elastic deformation of the coiled portion 572. The movable arm 573 can move out of (below) the first movement trajectory L₁ by moving obliquely downward about the vicinity of the base end portion. The movable arm 573 can move out of (interior of) the second movement trajectory L₂ by moving obliquely upward about the vicinity of the base end portion. The position at which the movable arm 573 is located outside the first movement trajectory L₁ is an example of an external position disclosed here.

FIG. 4A shows the configurations of the open lever 53, the lift lever 46, and the open link 56 when the movable arm 573 is located at the internal position, the open lever 53 is located at the initial position, and the open link 56 is located at the unlocked position. In this case, the inertial spring engagement portion 562 of the open link 56 is located on the normal side N and is in contact with the movable arm 573 located at the internal position. The movable arm 573 is pressed obliquely downward (toward the restriction side A) by the inertial spring engagement portion 562. However, at least a part (for example, the tip end portion) of the movable arm 573 is located inside the first movement trajectory L₁. FIG. 5A shows the configurations of the open lever 53, the lift lever 46, and the open link 56 when the movable arm 573 is located at the internal position, the open lever 53 is located at the initial position, and the open link 56 is located at the locked position. In this case, the inertial spring engagement portion 562 of the open link 56 is also located on the normal side N and is in contact with the movable arm 573 located at the internal position. The movable arm 573 is pressed obliquely downward (toward the restriction side A) by the inertial spring engagement portion 562.

FIGS. 7A and 7B are diagrams illustrating operations of the open link 56 and the inertial spring 57 when a side collision or the like occurs in the vehicle. When a side collision or the like occurs in the vehicle, an external force that causes the vehicle door 20 to move inward in the vehicle width direction may be applied. The open link 56 is rotatable in the vehicle width direction about the lower end portion of the open link 56, and thus remains at a position, before such an external force is applied, due to inertia. Therefore, when the open lever 53 is moved inward in the vehicle width direction by the external force, a force that causes the open link 56 to move outward in the vehicle width direction with respect to the open lever 53 is apparently applied to the open link 56 due to inertia. Hereinafter, such a force is referred to as an “inertial force”.

It is assumed that the inertial force is applied to the open link 56 in a state in which the open lever 53 is located at the initial position, the open link 56 is located at the unlocked position or the locked position, and the inertial spring engagement portion 562 of the open link 56 located on the normal side is in contact with the movable arm 573 located at the internal position (that is, the state illustrated in FIG. 5A or FIG. 6A). In this case, due to the inertial force, the open link 56 moves toward the inertia input position which is a position outer in the vehicle width direction with respect to the unlocked position and the locked position. At this time, the movable arm 573 is pressed downward by the inertial spring engagement portion 562 of the open link 56 and moves to the outside (external position) of the first movement trajectory L₁. Therefore, the open link 56 can move from the unlocked position and the locked position to the inertia input position.

When the open link 56 is located at the inertia input position, the inertial spring engagement portion 562 of the open link 56 is separated from the movable arm 573 of the inertial spring 57, and is located outer in the vehicle width direction with respect to the movable arm 573. Therefore, a pressing force acting on the movable arm 573 from the open link 56 is eliminated, and the inertial spring 57 enters the natural state in which the inertial spring 57 is not elastically deformed. Accordingly, the movable arm 573 is located at the internal position at which at least a part of the movable arm 573 enters the inside of the first movement trajectory L₁.

As described above, when the inertial spring 57 is in the natural state and the open link 56 is located at the inertia input position, as illustrated in FIG. 7A, the inertial spring engagement portion 562 of the open link 56 is located from the normal side N to the restriction side A.

Thereafter, when the open link 56 moves from the inertia input position toward the unlocked position due to, for example, disappearance of an inertia input, as illustrated in FIG. 7B, before the open link 56 reaches the unlocked position (for example, at the locked position), the inertial spring engagement portion 562 of the open link 56 engages with the hook portion 574 of the movable arm 573 of the inertial spring 57, and cannot further move toward the unlocked position. Thus, when the open link 56 moves to the inertia input position due to the inertial force, the lock mechanism 55 is held in the locked state until an operation to be described later is performed. Even when the open link 56 moves to the unlocked position against a biasing force of the inertial spring 57, the open link 56 is held in a state of being located on the restriction side A of the movable arm 573. Therefore, the open link 56 is pressed back to the locked position due to the biasing force of the inertial spring 57. Therefore, when a side collision or the like occurs, the vehicle door 20 can be prevented from being opened.

When the outside door handle 214 or the inside door handle 216 is operated once, the state returns to the state illustrated in FIG. 4A or FIG. 5A from the state illustrated in FIG. 7B. Specifically, when the open lever 53 is moved from the initial position toward the operating position by the operation of the outside door handle 214 or the inside door handle 216, the inertial spring engagement portion 562 of the open link 56 presses the movable arm 573 of the inertial spring 57 obliquely upward. Therefore, the movable arm 573 of the inertial spring 57 is pressed out of the second movement trajectory L₂ of the open link 56 (inward of the second movement trajectory L₂ in the vehicle width direction). Accordingly, the open link 56 can move from the initial position to the operating position.

When the open link 56 is located at the operating position, the inertial spring engagement portion 562 of the open link 56 is located above the movable arm 573 of the inertial spring 57 in a state in which the inertial spring engagement portion 562 is separated from the movable arm 573. Therefore, the inertial spring 57 returns to the natural state in which the inertial spring 57 is not elastically deformed. As a result, the movable arm 573 is in a state illustrated in FIG. 4B or FIG. 5B, that is, a state in which at least a part of the movable arm 573 is located in the second movement trajectory L₂ (a state in which the movable arm 573 is located at the internal position). In the state illustrated in FIG. 4B or FIG. 5B, the inertial spring engagement portion 562 is located on the normal side N. Accordingly, when the open link 56 together with the open lever 53 returns to the initial position from the operating position, the inertial spring engagement portion 562 of the open link 56 is in contact with the movable arm 573 on the normal side N. That is, the state illustrated in FIG. 4A or FIG. 5A is obtained.

As described above, when a force for moving the open link 56 from the unlocked position or the locked position toward the inertia input position is applied to the open link 56 due to a side collision or the like on the vehicle, the movable arm 573 of the inertial spring 57 is pressed by the inertial spring engagement portion 562 of the open link 56, and thus the movable arm 573 moves from the internal position to the external position (the outside of the first movement trajectory L₁). Therefore, the open link 56 can move to the inertia input position. When the open link 56 moves to the inertia input position, the movable arm 573 is separated from the open link 56 and returns to the internal position. Therefore, once the open link 56 moves to the inertia input position, the open link 56 is restricted from moving to the unlocked position (is held at the locked position) by the movable arm 573. Accordingly, the opening of the vehicle door 20 is prevented.

For example, the vehicle door lock device described in JP 2019-183614A has a configuration for preventing the open link 56 from moving to the unlocked position when an inertial force is input due to a side collision or the like. The vehicle door lock device requires two members, that is, a block member that moves to a block position by the inertial force and a biasing member that biases the block member in a predetermined direction at the block position. In contrast, according to the present embodiment, an operation of preventing the open link 56 from moving to the unlocked position when the inertial force is input due to the side collision or the like can be achieved only by the inertial spring 57. According to the present embodiment, since the operation is achieved by the inertial spring 57, an increase in the number of components of the door lock device 10 can be prevented.

When a side collision occurs in the vehicle, an external force for moving the door lock device 10 attached to the vehicle door 20 inward in the vehicle width direction is applied to the door lock device 10. According to the present embodiment, since the open link 56 is movable in the vehicle width direction with respect to the open lever 53, a direction of the inertial force generated in response to the external force caused by the side collision or the like can be brought close to a movement direction of the open link 56. Accordingly, the reliability of the movement of the open link 56 to the inertia input position by the inertial force can be improved.

As described above, the movable arm 573 is inclined with respect to the extending direction (substantially the vehicle width direction) of the first movement trajectory L₁. Therefore, according to such a configuration, a movement amount of the movable arm 573 (an elastic deformation amount of the inertial spring 57) when the open link 56 moves from the unlocked position and the locked position to the inertia input position can be reduced compared to a configuration in which the movable arm 573 is not inclined (a configuration in which the movable arm extends in a direction perpendicular to the extending direction of the first movement trajectory L₁). Accordingly, the movable arm 573 of the inertial spring 57 can improve the reliability of the operation of allowing the movement of the open link 56 from the unlocked position and the locked position to the inertia input position. A specific value of an inclination angle of the movable arm 573 with respect to the extending direction of the first movement trajectory L₁ is not limited. The inclination angle is appropriately set according to a mass (in other words, the inertial force) of the open link 56, a spring constant of the inertial spring 57, and the like.

When the movable arm 573 is provided with the hook portion 574 as described above, when the open link 56 moves from the inertia input position toward the unlocked position, the hook portion 574 engages with the inertial spring engagement portion 562 of the open link 56, so that the reliability of preventing the open link 56 from moving to the unlocked position can be improved.

According to the present embodiment, since an inexpensive torsion spring can be applied to the inertial spring 57, an increase in a component cost can be prevented.

According to the present embodiment, at least a part of the inertial spring 57 overlaps the open link 56 as viewed in the front-rear direction. According to such a configuration, an increase in a size of the vehicle door lock device 10, in particular, an increase in a dimension (a dimension in the vehicle width direction and a dimension in the upper-lower direction) of the vehicle door lock device 10 as viewed in a direction parallel to the rotation center line C₂ of the open link 56 with respect to the open lever 53 can be prevented.

The movable arm 573 of the inertial spring 57 does not inhibit the operation of the lock mechanism 55 when the inertial spring engagement portion 562 of the open link 56 is located on the normal side N. Specifically, the case is as follows. As illustrated in FIG. 4A, in a state in which the open lever 53 is located at the initial position and the open link 56 is located at the unlocked position or the locked position, the inertial spring engagement portion 562 of the open link 56 is located on the normal side N. At this time, since the inertial spring engagement portion 562 of the open link 56 is only in contact with the movable arm 573 of the inertial spring 57 on the normal side N, when the open lever 53 moves toward the operating position from this state and the open link 56 rises, the inertial spring engagement portion 562 of the open link 56 is separated from the movable arm 573. Accordingly, the movement of the open link 56 from the initial position to the operating position is not more inhibited by the inertial spring 57. Thereafter, when the open link 56 moves (returns) from the operating position to the initial position, the open link 56 returns to the state illustrated in FIG. 4A or FIG. 5A.

Here, a configuration example of the latch mechanism will be briefly described. As described above, the latch mechanism includes the latch 44, the pawl 45, the lift lever 46, the latch return spring, and the pawl return spring.

The latch 44 includes a full latch claw, a half latch claw, and a striker holding groove. The full latch claw and the half latch claw have a plate-shaped configuration extending radially outward from a rotation center of the latch 44. The striker holding groove is a groove through which a striker 302 provided in the vehicle body 301 can be inserted and removed, and is provided between the full latch claw and the half latch claw.

The latch 44 is rotatably supported with respect to the cabinet of the meshing body 40, and is movable between a latched position and an unlatched position by rotating. The latched position of the latch 44 is a position at which the striker 302 is held when the vehicle door 20 is located at the closed position (in other words, a position at which engagement between the latch 44 and the striker 302 cannot be released). When the latch 44 is held at the latched position while the vehicle door 20 is located at the closed position, the movement of the vehicle door 20 from the closed position to the open position is not allowed. The unlatched position of the latch 44 is a position at which the striker 302 provided in the vehicle body 301 and the latch 44 are detachably engaged with each other (a position at which the striker 302 is freely inserted into and removed from the striker holding groove). When the latch 44 moves from the unlatched position to the latched position while the vehicle door 20 is located at the closed position, the movement of the vehicle door 20 from the closed position to the open position is allowed. The latch 44 is constantly elastically biased toward the unlatched position by the latch return spring.

The pawl 45 and the lift lever 46 are rotatably supported with respect to a cabinet of the door lock device 10. The pawl 45 and the lift lever 46 are engaged with each other and rotate integrally. The pawl 45 and the lift lever 46 are movable between the latch engagement position and the latch non-engagement position by rotating. The latch engagement position of the pawl 45 and the lift lever 46 is a position at which the pawl 45 engages with the latch 44 to hold the latch 44 at the latched position (a position at which the movement of the latch 44 from the latched position to the unlatched position is restricted). The latch non-engagement position of the pawl 45 and the lift lever 46 is a position outside a rotation trajectory of the latch 44 and is a position at which the latch 44 is allowed to move from the latched position to the unlatched position. The pawl 45 and the lift lever 46 are constantly elastically biased toward the latch engagement position by the pawl return spring.

When the vehicle door 20 is located at the closed position and the latch 44 is located at the latched position, if the pawl 45 and the lift lever 46 are located at the latch engagement position, the pawl 45 engages with the latch 44. Accordingly, the pawl 45 holds the latch 44 at the latched position. Therefore, the vehicle door 20 is held at the closed position (in other words, movement to the open position is restricted). The state of the latch mechanism is a latched state. When the vehicle door 20 is located at the closed position and the latch mechanism is in the latched state, if the pawl 45 and the lift lever 46 move from the latch engagement position to the latch non-engagement position against the biasing force of the pawl return spring, the pawl 45 is located outside movement trajectories of the full latch claw and the half latch claw of the latch 44. The latch 44 moves from the latched position to the unlatched position by a biasing force of the latch return spring, and the latch 44 enters a state of not holding the striker 302 (a state of being detachably engaged with each other). Therefore, the vehicle door 20 is allowed to move to the open position. This state of the latch mechanism is the unlatched state.

When the latch mechanism is in the unlatched state, if the vehicle door 20 moves from the open position toward the closed position, the latch 44 is pressed by the striker 302 and moves from the unlatched position toward the latched position. At this time, the latch 44 can move from the unlatched position to the latched position by pressing the pawl 45 out of a rotation trajectory of the latch 44 (moving the pawl 45 from the latch engagement position to the latch non-engagement position). When the vehicle door 20 reaches the closed position, the latch 44 reaches the latched position, and the pawl 45 and the lift lever 46 are held at the latch engagement position by the biasing force of the pawl return spring. Accordingly, the latch mechanism is switched from the unlatched state to the latched state.

As described above, when the vehicle door 20 is located at the closed position, as the pawl 45 and the lift lever 46 rotate from the latch engagement position to the latch non-engagement position, the latch mechanism switches from the latched state to the unlatched state. The latch mechanism may switch from the latched state to the unlatched state when the lift lever 46 moves from the latch engagement position to the latch non-engagement position. The specific configuration is not limited to the above-described configuration example. Various known configurations can be applied to the latch mechanism.

### Lock Mechanism

Next, a configuration example of the lock mechanism 55 will be described. The lock mechanism 55 includes an active lever 58, a control lever 59, a key lever 60, an actuator 61, and a wheel gear 62 in addition to the open link 56 and the inertial spring 57. The lock mechanism 55 is switchable between the unlocked state and the locked state by a predetermined manual operation of the user and a driving force of the actuator 61.

The active lever 58 is rotatably (swingably) attached to the cabinet, and is movable between a locked position and an unlocked position by rotating with respect to the cabinet. The locked position is a position of one end of the active lever 58 in a rotatable range with respect to the cabinet, and the unlocked position is a position of the other end. When the active lever 58 is located at the locked position, the movement of the open link 56 from the locked position to the unlocked position is restricted. When the active lever 58 is located at the unlocked position, the movement of the open link 56 from the unlocked position to the locked position is restricted. The active lever 58 is elastically biased toward the locked position by a detent spring when the active lever 58 is located closer to the locked position than a turn over point that is an intermediate position between the locked position and the unlocked position, and is elastically biased toward the unlocked position when the active lever 58 is located closer to the unlocked position than the turn over point. Therefore, in a state in which no external force other than that of the detent spring is applied, the active lever 58 is held at either the locked position or the unlocked position.

The control lever 59 is rotatably supported with respect to the cabinet, and is movable to a neutral position, an unlocked position, and a locked position by rotating. The unlocked position is a position of one end of the control lever 59 in a rotatable range, the locked position is a position of an end opposite to the one end of the control lever 59 in the rotatable range, and the neutral position is an intermediate position between the unlocked position and the locked position. The control lever 59 is linked to the inner cylinder of the key cylinder 215 and the active lever 58 via the key lever 60. When the user operates the key cylinder 215 to rotate the inner cylinder from a neutral position to a locked position, the control lever 59 moves from the neutral position to the locked position by the movement of the inner cylinder, and causes the active lever 58 to move from the unlocked position to the locked position. When the user operates the key cylinder 215 to rotate the inner cylinder from the neutral position to an unlocked position, the control lever 59 moves from the neutral position to the unlocked position by the movement of the inner cylinder, and causes the active lever 58 to move from the locked position to the unlocked position. Accordingly, the user or the like of the vehicle can switch the lock mechanism between the unlocked state and the locked state by operating the key cylinder.

The control lever 59 is coupled to the lock knob 217 via a coupling member (not illustrated). When the lock knob 217 is located at an unlocked position, the control lever 59 is also located at the unlocked position, and when the lock knob 217 is located at a locked position, the control lever 59 is also located at the locked position. Accordingly, the user or the like of the vehicle can switch the lock mechanism 55 between the unlocked state and the locked state by operating the lock knob 217.

The actuator 61 is a driving force source of the active lever 58. An electric motor capable of outputting rotational power in both forward and reverse directions is applied to the actuator 61. The wheel gear 62 is rotatably supported with respect to the cabinet, and is rotated by the driving force of the actuator 61. When the wheel gear 62 is rotated in a predetermined direction by the rotational power of the actuator 61, the wheel gear 62 engages with the active lever 58, and causes the active lever 58 to move from the locked position to the unlocked position. On the other hand, when the wheel gear 62 rotates in a direction opposite to the predetermined direction by the rotational power of the actuator 61, the wheel gear 62 engages with the active lever 58, and causes the active lever 58 to move from the unlocked position to the locked position. As described above, the lock mechanism 55 is switchable between the unlocked state and the locked state by the driving force of the actuator 61 causing the active lever 58 to move.

Although the embodiment disclosed here is described above, this disclosure is not limited to the above embodiment. Various modifications can be made to the embodiment disclosed here without departing from the spirit thereof, and such modifications are also included in the technical scope of the embodiment disclosed here.

For example, in the above embodiment, although the configuration in which the torsion spring is applied to the inertial spring 57 is illustrated, the inertial spring 57 is not limited to the torsion spring. For example, a long plate spring may be applied to the inertial spring 57. In this case, one end portion of the plate spring in a longitudinal direction of the plate spring is fixed to the cabinet, and the other portion functions as a portion corresponding to the movable arm 573.

According to an aspect of this disclosure, a door lock device includes:
a latch mechanism configured to be switchable between a latched state in which opening of a vehicle door provided on a vehicle is not allowed and an unlatched state in which opening of the vehicle door is allowed;
a first member rotatably supported with respect to a cabinet and configured to be movable between an initial position and an operating position;
a second member rotatably supported by the first member, and configured to be movable among a first position, a second position, and a third position between the first position and the second position by rotating with respect to the first member, movable between the initial position and the operating position together with the first member, switch the latch mechanism from the latched state to the unlatched state when moving from the initial position to the operating position in a state of being located at the first position, and hold the latch mechanism in the latched state when moving from the initial position to the operating position in a state of being located at the third position; and
a third member configured to allow movement of the second member by being elastically deformed while being in contact with the second member when the second member moves in a direction from the first position or the third position toward the second position, be detached from the second member and return to a natural state when the second member moves to the second position, and restrict the movement of the second member by engaging with the second member when the second member moves in a direction from the second position toward the first position after the third member returns to the natural state.

According to this disclosure, when a side collision or the like occurs in the vehicle and a force (inertial force) for moving the second member from the first position and the third position to the second position is applied to the second member, the third member allows the second member to move from the first position and the third position to the second position. After the second member moves to the second position, the third member restricts (prevents) the second member from moving from the second position to the first position. Therefore, the second member is held at the third position at which the latch mechanism is held in the latched state (the latch mechanism is not switched from the latched state to the unlatched state) even if the second member moves from the initial position to the operating position. Accordingly, the opening of the vehicle door is prevented. According to this disclosure, since the above operation is achieved only by adding such a restriction member, an increase in the number of components of the vehicle door lock device can be prevented.

A configuration may be adopted in which
the third member includes an attachment unit attached to the cabinet, and
the restriction unit has a rod-shaped configuration extending from the attachment unit, and is inclined with respect to a movement trajectory in a direction in which a tip end portion of the restriction unit is closer to the second position than a base end portion of the restriction unit when viewed in a direction of a rotation center line of the second member with respect to the first member, the base end portion being an end portion closer to the attachment unit and the tip end portion being an end portion opposite to the base end portion.

According to such a configuration, a movement amount of the restriction unit when the second member moves from the first position and the third position to the second position can be reduced compared to a configuration in which the restriction unit is not inclined. Therefore, the reliability of the operation of allowing the movement of the second member from the first position and the third position to the second position can be improved.

A configuration may be adopted in which
the tip end portion of the restriction unit is provided with an extending portion that extends toward the second position when the third member is in the natural state.

According to such a configuration, when the second member moves from the second position toward the first position, the reliability of the operation of preventing the second member from moving to the first position can be improved by engaging the extending portion with the second member.

A configuration may be adopted in which
the third member is a torsion spring including a coiled portion and two arms respectively provided at end portions of the coiled portion, and
one of the two arms is the restriction unit, and
at least one of the other one of the two arms and the coiled portion is the attachment unit.

According to such a configuration, since an inexpensive torsion spring is applied as the restriction member, an increase in a component cost can be prevented.

A configuration may be adopted in which
the second member is rotatable with respect to the first member about a straight line substantially parallel to a front-rear direction of the vehicle, and
the first position is a position on an end portion of the vehicle outer in a vehicle width direction in a range rotatable with respect to the first member, the second position is a position on an end portion of the vehicle inner in the vehicle width direction in the rotatable range, and the third position is an intermediate portion of the vehicle in the vehicle width direction in the rotatable range.

When a side collision occurs in the vehicle, an external force for moving the vehicle door lock device attached to the vehicle door inward in the vehicle width direction is applied to the vehicle door lock device. When the door lock device is moved inward in the vehicle width direction by the external force, the second member is retained at a position before movement due to inertia, and thus an inertial force that causes the second member to move outward in the vehicle width direction with respect to the first member is apparently applied to the second member. Therefore, according to the configuration, when such an inertial force is applied to the second member, the second member moves from the first position and the third position to the second position. After the second member moves to the second position, the movement to the first position is restricted as described above, and thus the latch mechanism is prevented from switching from the latched state to the unlatched state. Accordingly, according to the configuration, when a side collision or the like occurs in the vehicle, the reliability of preventing the latch mechanism from switching from the latched state to the unlatched state can be improved.

A configuration may be adopted in which
when viewed in a direction parallel to the rotation center line of the second member with respect to the first member, at least a part of the third member overlaps the second member.

According to such a configuration, an increase in a size of the vehicle door lock device, in particular, an increase in a dimension of the vehicle door lock device as viewed in a direction parallel to the rotation center line of the second member with respect to the first member can be prevented.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle door lock device comprising:
a latch mechanism configured to be switchable between a latched state in which opening of a vehicle door provided on a vehicle is not allowed and an unlatched state in which opening of the vehicle door is allowed;
a first member rotatably supported with respect to a cabinet and configured to be movable between an initial position and an operating position;
a second member rotatably supported by the first member, and configured to be movable among a first position, a second position, and a third position between the first position and the second position by rotating with respect to the first member, movable between the initial position and the operating position together with the first member, switch the latch mechanism from the latched state to the unlatched state when moving from the initial position to the operating position in a state of being located at the first position, and hold the latch mechanism in the latched state when moving from the initial position to the operating position in a state of being located at the third position; and
a third member configured to allow movement of the second member by being elastically deformed while being in contact with the second member when the second member moves in a direction from the first position or the third position toward the second position, be detached from the second member and return to a natural state when the second member moves to the second position, and restrict the movement of the second member by engaging with the second member when the second member moves in a direction from the second position toward the first position after the third member returns to the natural state.

2. The vehicle door lock device according to claim 1, wherein
the third member includes an attachment unit attached to the cabinet and a restriction unit having a rod-shaped configuration extending from the attachment unit, and
the restriction unit is inclined with respect to a movement trajectory in a direction in which a tip end portion of the restriction unit is closer to the second position than a base end portion of the restriction unit when viewed in a direction of a rotation center line of the second member with respect to the first member, the base end portion being an end portion closer to the attachment unit and the tip end portion being an end portion opposite to the base end portion.

3. The vehicle door lock device according to claim 2, wherein
the tip end portion of the restriction unit is provided with an extending portion that extends toward the second position when the third member is in the natural state.

4. The vehicle door lock device according to claim 2, wherein
the third member is a torsion spring including a coiled portion and two arms respectively provided at end portions of the coiled portion,
one of the two arms is the restriction unit, and
at least one of the other one of the two arms and the coiled portion is the attachment unit.

5. The vehicle door lock device according to claim 1, wherein
the second member is rotatable with respect to the first member about a straight line substantially parallel to a front-rear direction of the vehicle, and
the first position is a position on an end portion of the vehicle outer in a vehicle width direction in a range rotatable with respect to the first member, the second position is a position on an end portion of the vehicle inner in the vehicle width direction in the rotatable range, and the third position is an intermediate portion of the vehicle in the vehicle width direction in the rotatable range.

6. The vehicle door lock device according to claim 1, wherein
when viewed in a direction parallel to the rotation center line of the second member with respect to the first member, at least a part of the third member overlaps the second member.

7. The vehicle door lock device according to claim 2, wherein
when viewed in a direction parallel to the rotation center line of the second member with respect to the first member, at least a part of the third member overlaps the second member.

8. The vehicle door lock device according to claim 3, wherein
when viewed in a direction parallel to the rotation center line of the second member with respect to the first member, at least a part of the third member overlaps the second member.

9. The vehicle door lock device according to claim 4, wherein
when viewed in a direction parallel to the rotation center line of the second member with respect to the first member, at least a part of the third member overlaps the second member.

10. The vehicle door lock device according to claim 5, wherein
when viewed in a direction parallel to the rotation center line of the second member with respect to the first member, at least a part of the third member overlaps the second member.
